(19) United States
(12) Patent Application Publication
(10) Pub. No.: US 2002/0002079 A1
(43) Pub. Date: Jan. 3, 2002

(54) Combination jukebox and game

(76) Inventors: John R. Martin, Rockford, IL (US); Patrick G. Rice, Loves Park, IL (US)

Correspondence Address: John J. Held, McAndrews, Held & Malloy, Ltd., 34th Floor, 500 West Madison Street, Chicago, IL, 60661, US

(21) Appl. No.: 09/934,498

(22) Filed: Aug. 22, 2001

Related U.S. Application Data
(63) Continuation-in-part of application No. 09/309,400, filed on May 11, 1999.
Application No. 09/309,400 is a continuation of application No. 08/975,612, filed on Nov. 21, 1997, now Pat. No. 5,930,765.
Application No. 08/975,612 is a continuation of application No. 08/638,022, filed on Apr. 25, 1996, now Pat. No. 5,848,398.
Application No. 08/975,612 is a continuation of application No. 09/426,047, filed on Oct. 25, 1999.

(51) Int. Cl. A63F 13/00

(52) U.S. Cl. 463/42

(57) ABSTRACT

A combination entertainment system for providing both jukebox and game entertainment is disclosed. The entertainment system comprises a jukebox subsystem, a dart game subsystem, and a control subsystem that coordinates a jukebox mode of operation and a dart game mode of operation. Also disclosed is a method of operation for the combination jukebox and game entertainment system. The method transfers operation between game, jukebox, and advertisement modes of operation, based on patron input and the current operating mode of the system.

### BACKGROUND OF THE INVENTION

The present invention relates generally to electronic entertainment devices. More specifically, the present invention relates to a combination jukebox and electronic game(s).

Electronic entertainment devices are common in many types of establishments, including arcades, taverns, restaurants and nightclubs. Dart games are among the most popular electronic entertainment devices. Of course, music is also one of the most popular forms of entertainment, but require establishments to provide separate electronic music devices (e.g., expensive jukeboxes) that enable patrons to select and play desired music.

Floor space is a valuable commodity for many entertainment establishments. Electronic entertainment devices and jukeboxes, however, occupy valuable floor space that could otherwise be profitably used, for example, for additional customer seating. An important consideration, therefore, in the design of new electronic entertainment devices is reducing their footprint.

Another important concern is operating expense, including taxes, fees, electricity, and maintenance expenses incurred for each electronic entertainment device or jukebox operated. Reducing the number of operational gaming systems in an entertainment establishment may in many instances reduce overall operating expenses.

A further consideration is the initial cost associated with providing an establishment with jukeboxes and each gaming system. Because of their sophisticated capabilities and complex structure, electronic entertainment devices are typically significant investments. An establishment owner may therefore need to invest a substantial sum of money to adequately meet patron demand for entertainment.

A need has long existed for a combination jukebox and electronic game that provides multiple functionalities in a single entertainment system.

### SUMMARY OF THE INVENTION

Accordingly, it is an object of present invention to provide an entertainment system including a jukebox and at least one electronic game.

It is a further object of the present invention to provide a method and apparatus for combining jukebox and electronic game(s) functionality in a single unit.

It is a still further object of the present invention to provide a method and apparatus for combining jukebox and dart game functionality in a single unit in which system components are shared between jukebox functions and dart game functions.

One or more of the foregoing objects is met in whole or in part by a preferred embodiment of an entertainment system including jukebox and dart game functionality. The entertainment system includes a game subsystem (including, for example, a dart board and dart board interface), and a jukebox subsystem (including, for example, music data decoding hardware and high quality sound output devices). The entertainment system further includes a control subsystem for directing and supervising overall operation of the entertainment system. The combined operation of the jukebox subsystem and the control subsystem provides a jukebox mode of operation. In addition, the combined operation of the game subsystem and the control subsystem provides a dart game mode of operation. The control subsystem may also provide for display of advertising and other information services (e.g., weather reports and news headlines).

The present invention also provides a method of operation of an entertainment system providing an electronic game(s) and jukebox functionality. The system operates in a current mode of operation that may be, for example, a jukebox mode, a dart game mode or an advertising mode. The method includes receiving a mode command from a patron. The method then determines a next mode of operation based on factors including the mode command received from the patron and the current mode of operation. The mode of operation of the entertainment system is then set to a determined next mode. Upon completion of a particular mode of operation, the entertainment system may automatically resume operation in the previous mode (or any other mode).

### BRIEF DESCRIPTION OF THE DRAWINGS

FIG. 1 illustrates a high-level block diagram of a combination entertainment system.

FIG. 2 illustrates a block diagram of a combination jukebox and dart game entertainment system.

FIG. 3 shows a flow diagram illustrating a method of operation of a combination jukebox and dart game entertainment system.

### DETAILED DESCRIPTION OF THE PREFERRED EMBODIMENT

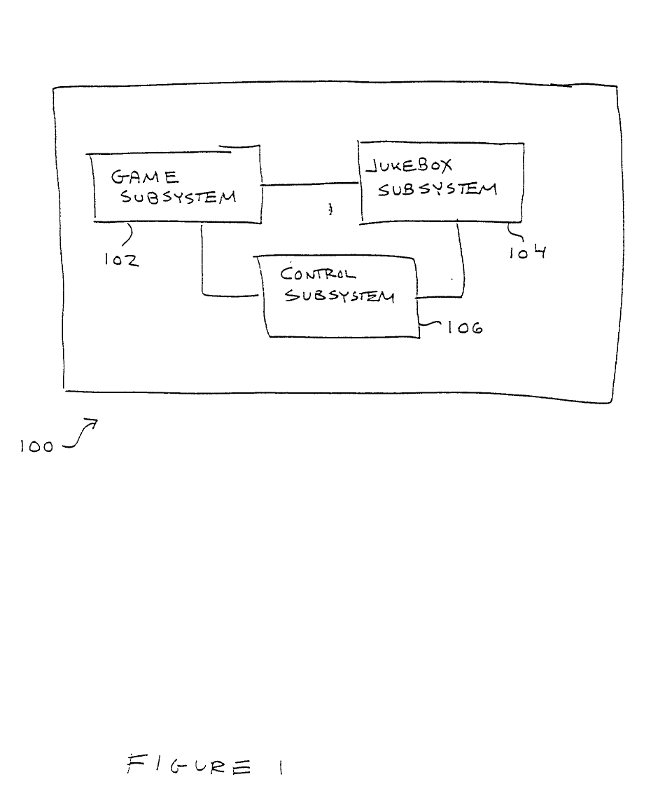

FIG. 1 illustrates a combination entertainment system 100. The combination entertainment system 100 includes a game subsystem 102, a jukebox subsystem 104, and a control subsystem 106. The game subsystem 102 includes the hardware and software that implement an electronic game (e.g., one or more variants of the game of darts). The jukebox subsystem 104 includes the hardware and software that implement a computer jukebox, and the control subsystem 106 includes the hardware and software that exercise coordinated control over the game subsystem 102 and the jukebox subsystem 104. The computer jukebox subsystem 104 may, for example, download and store digitized songs on its hard drive for subsequent playback, or may play digitized songs by receiving and processing song data streamed directly from a remote server. An example of a jukebox subsystem is disclosed in U.S. Pat. No. 5,848,398, which is assigned to the assignee of the present application; although those skilled in this art will recognize that other jukebox subsystems may also be used. Although described below with reference to dart games, it is noted that the jukebox subsystem 104 may be combined with any type or kind of electronic game (e.g., a video poker game, golf games, etc.) or entertainment device (e.g., an arcade video game).

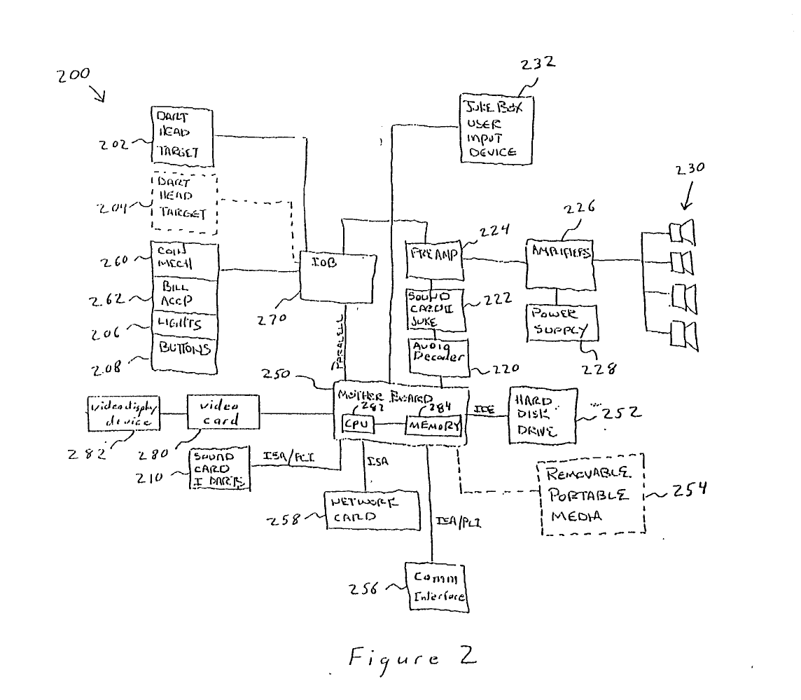

Turning now to FIG. 2, that figure shows a detailed block diagram of a combination entertainment system according to a preferred embodiment of the present invention. The entertainment system 200 implements a combined jukebox and dart game and includes a dart head target 202, and, optionally, additional targets such as the second dart head target 204. The lights 206 are provided to communicate information or provide an attractive display for the patron, and the buttons 208 accept input from the patron. Some or all of the lights 206 and buttons 208 may be used for both jukebox mode and dart game mode of the entertainment system 200. A sound card 210 preferably provides dart game specific sound. The entertainment system 200 accepts payment through a coin mechanism 260 and/or a bill acceptance mechanism 262.

The entertainment system 200 preferably includes an audio data decoder 220. The data decoder 220 receives encoded audio data and produces decoded audio information. The data decoder 220 may be a decoder for any one or more popular encoding techniques including, for example, MP3, MS Audio 4, Madison Project, Liquid Audio and A2B. The data decoder 220 may be implemented in hardware only, or may be implemented using a processor executing decoding software. The data decoder 220 provides decoded audio information to a high quality sound card 222 or digital to analog converter, which provides music output at the desired quality for jukebox operation. The pre-amp 224, in turn, generates a pre-amplified output signal for the amplifier 226 that, in turn, provides the final amplification of the audio signal to a desired power level for the speakers 230. A power supply 228 supplies the necessary power to the amplifier 226. A jukebox interface 232 is preferably provided that allows a patron to easily select or request songs. To that end, the jukebox interface 232 may be, for example, a touch screen in place over the display device 282.

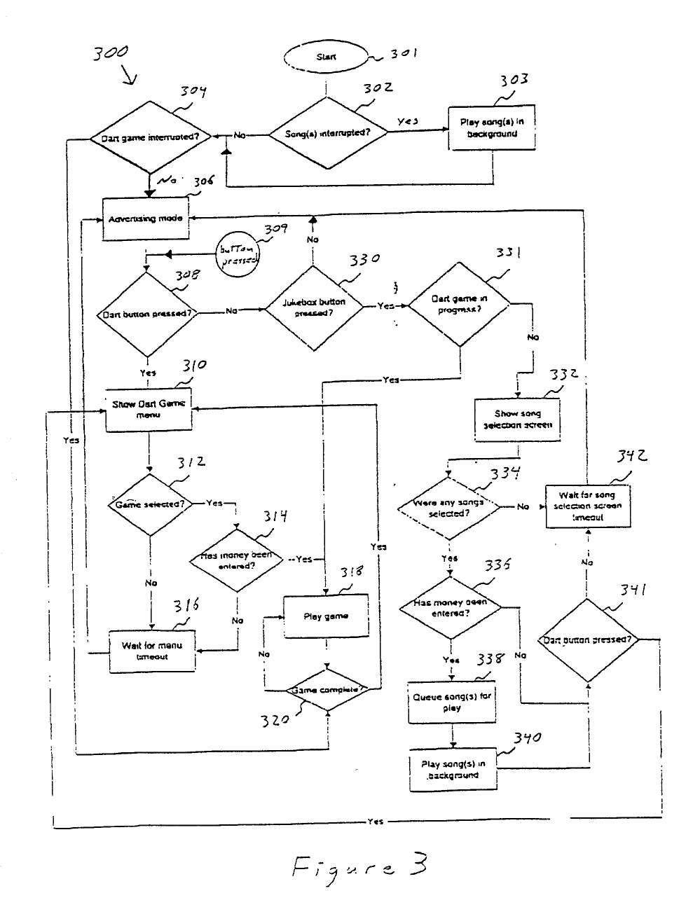

Also shown in FIG. 2 is a motherboard 250 that provides control over the operation of the entertainment system 200. In particular, the motherboard 250 (through its CPU and associated software) exercises control over jukebox and dart game modes of operation, as discussed in more detail below with respect to FIG. 3.

The motherboard 250 communicates with a mass data storage device 252, such as a hard disk drive. The mass data storage device 252 stores data for use for dart game, jukebox, and advertisement operation. Removable portable media 254 (e.g., a removable disk system) may also be provided for transferring data to and from the system 200.

As noted above, the game subsystem 102 includes the hardware and software used to implement game functionality. As shown in FIG. 2, the dart game subsystem may include dart game specific hardware, such as the dart targets 202, 204 and the sound card 210, used only for dart game mode. Similarly, the jukebox subsystem 104 may include jukebox only hardware, such as the audio decoder 220, the preamplifier 224, and the amplifier 226, used only for jukebox mode. In addition, the game subsystem 102 and the jukebox subsystem 104 may include common components used for both modes of operation. As an example, the game subsystem 102 and the jukebox subsystem 104 share use of the I/O board 270, video card 280, and video display device 282. The control subsystem 104, as noted above, includes the hardware and software to exercise control over the entertainment system. To that end, the control subsystem 104 may generally be considered to include the motherboard 250, CPU 284, and memory 286 (which stores the program executed by the CPU 284).

Still referring to FIG. 2, the entertainment system 200 also includes a communications interface 256 (for example, a modem card) and/or a network card 258. The communications interface 256 and network card 258 allow the entertainment system 200 to communicate data (e.g., new digitized songs or dart game programs) between the system 200 and a remote station, or to connect to and share game or tournament data, as examples, with other entertainment systems.

An I/O board 270, (including, for example, data buffers and read/write control logic) coupled to the motherboard 250, controls input and output operations for the entertainment system 200. As an example, the dart head target 204 provides input representative of dart hits, and is accordingly coupled to the I/O board 270. In a similar fashion, the coin mechanism 260 and bill acceptance mechanism 262 are coupled to the I/O board 270, as are the output lights 206 and input buttons 208. The I/O board 270 is also coupled to the pre-amp 224 to enable or disable jukebox music output.

The entertainment system 200 uses a video card 280 and video display device 282 to present to the patron game information, jukebox song selection information, advertisement information, and the like.

In an alternate embodiment, the jukebox interface 232 may be physically separated from the entertainment system 200 itself, although still connected to, controlled by, and processed by the CPU 284. Thus, for example, a touchpad, keyboard, mouse, or other pointing device may be provided some distance from the dart target 202. The jukebox interface 232 thereby allows players to make music selections while other players interact with the dart game.

Referring now to FIG. 3, that figure shows a flow chart 300 of the operation of the entertainment system 200. When the system 200 is turned on or reset, operation begins at block 301. The system 200 checks, at step 302, whether a song was interrupted the last time the system 200 was operating. If song play was interrupted, the system 200 resumes playing songs in the background at step 303.

After checking for song play interruption and resuming song play at steps 302 and 303 (if necessary), the system 200 checks to see, at step 304, if dart game play was interrupted the last time the system 200 was operating. If dart game play was interrupted, the system 200 resumes dart game play at steps 318 and 320. If a dart game was not interrupted, the system 200 enters the advertising mode at step 306.

In advertising mode 306, the system 200 outputs advertising information on the video display 282. Once in advertising mode 306, the system 200 waits for a patron to select either the dart game mode or the jukebox mode of operation.

The flow chart 300 illustrates two techniques for checking for a patron mode request input. In the first technique, the system 200 polls a dart button at step 308 to determine if a patron has requested dart game mode. If dart game mode has not been requested, the system 200 polls a jukebox button at step 330 to determine if jukebox mode has been requested by a patron. If neither dart game mode nor jukebox mode has been requested by a patron, system operation returns to the advertising mode step 306, where the dart game mode check 308 and jukebox mode check 330 are made again. The polling loop of steps 306, 308 and 330 continues until the patron inputs a mode selection.

As a second technique, the system 200 may respond to interrupts to check for patron requests. If the patron makes a mode request, the system 200 generates an interrupt to the CPU 284. In the flow diagram 300, the mode request interrupt service routine starts at step 309 and checks for the service button pressed at steps 308 and 330. The polling technique and interrupt technique for patron mode request detection may alternatively be used separately or in combination.

Returning to step 308, when the system 200 determines that the patron selected the dart game mode, the system 200 displays a dart game menu to the patron at step 310. The dart game menu preferably displays a list of dart game options including, for example, the number of players or the specific dart game variation. The system 200 subsequently performs a game check at step 312 to determine whether the patron has yet chosen a specific dart game.

If a dart game was chosen, the system 200 performs a money check at step 314 to determine if the patron deposited the appropriate amount of money. If a specific dart game is not selected or dart game money is not provided within a predetermined time period (during which the system 200 waits for input at step 316), system operation returns to the advertising mode at step 306.

However, if a patron selects a specific dart game and provides an appropriate amount of money within the set time period, dart game play begins at step 318. The system 200 checks for the game to be completed at step 320. If the game is not over, system operation continues back at the dart game play step 318. If the game is complete, the system 200 returns to displaying the dart game menu at step 310.

Returning to step 330, when the system 200 detects a jukebox mode request, the system 200 performs a game-in-progress check at step 331. If a game is currently in progress, the system preferably resumes operation at the game playing step 318. Thus, in one embodiment, a request for jukebox mode is not allowed to interrupt a dart game in progress. However, in an alternative embodiment, the system 200 may allow a jukebox mode request to temporarily interrupt a game. The game may then resume upon the completion of jukebox mode.

Returning to step 331, if it is determined that no dart game is in progress, the system 200 displays a song selection screen at step 332. The system next performs a song selection check at step 334. If the system 200 determines that song selection has occurred, the system 200 checks deposited funds at step 336. If the system 200 determines that the appropriate amount of money to play the requested songs has been deposited, the system queues the songs for play at step 338. The system 200 then plays the songs in the background at step 340.

The system 200 may thereby provide high quality music entertainment in the background while patrons play a game. As shown in FIG. 3, the system 200 checks the dart button at step 341, thereby enabling a patron to quickly return to the game mode at step 310.

The system 200 also monitors for additional song selections at step 342. A song selection timeout at step 342 results in the system returning to advertising mode at step 306.

Thus, when the current mode is the dart game mode, the entertainment system 200 allows a patron to play a dart game. When the current mode switches to jukebox mode, the entertainment system 200 allows a patron to select songs and optionally have those songs played in the background while playing a game. The entertainment system 200 also provides an advertising mode as a current mode of operation that allows an establishment owner to increase revenues through advertising. The entertainment system 200 reverts automatically, in certain instances as shown in FIG. 3, to a mode of operation prior to the current mode of operation (i.e., a previous mode of operation) to allow the entertainment system 200, for example, to continue to display advertising.

The present invention thereby provides a single entertainment system 200 that includes both jukebox and game functionalities. The system 200 reduces floor space requirements while maintaining the level of entertainment provided. The system 200 also provides cost savings by reducing the number of individual systems required by an establishment for a given amount of entertainment. The system further provides cost savings by sharing expensive system components between game and jukebox operation, thereby reducing the overall number of system components necessary to provide game and jukebox entertainment.

While particular elements, embodiments and applications of the present invention have been shown and described, it will be understood that the invention is not limited thereto since modifications may be made by those skilled in the art, particularly in light of the foregoing teachings. In this regard, the invention, as described above, has focused primarily on enhancements where the electronic game, or game subsystem, is an electronic dart game. However, those skilled in the art should recognize and appreciate that other electronic game(s) could be used in place of or in substitution for the electronic dart game described. It is therefore contemplated by the appended claims to cover such modifications as incorporate those features, which come within the spirit and scope of the invention.

What is claimed is:

1. An entertainment system comprising:
a game subsystem;
a jukebox subsystem; and
a control subsystem coupled to the game subsystem and the jukebox subsystem, the control subsystem and the game subsystem providing game functionality, and the jukebox subsystem and the control subsystem providing jukebox functionality.

2. The entertainment system of claim 1, wherein the control system is responsive to at least one mode determining switch for specifying a mode of operation for said entertainment system.

3. The entertainment system of claim 1, wherein the control subsystem comprises a central processor for controlling operation of the game subsystem and the jukebox subsystem apparatus.

4. The entertainment system of claim 1, wherein the game subsystem is a dart game subsystem.

5. The entertainment system of claim 3, further comprising a data storage device coupled to said central processor, said data storage device storing digitized songs for the jukebox subsystem.

6. The entertainment system of claim 3, wherein the central processor is operative to play audio data streamed from a remote server while providing jukebox functionality.

7. The entertainment system of claim 3, further comprising a communication interface for communicating with devices external to the entertainment system.

8. The entertainment system of claim 1, wherein the jukebox subsystem comprises an audio data decoder, an amplifier, and at least one speaker.

9. The entertainment system of claim 8, wherein the game subsystem is a dart game subsystem comprising a dart target and a sound card.

10. The entertainment system of claim 1, wherein the jukebox subsystem includes a jukebox interface physically separated from the entertainment system for allowing players to interact with the jukebox subsystem while other players interact with the game subsystem.

11. A method for providing an entertainment system having combined jukebox and game functionality, the method comprising:
operating in a current mode of operation corresponding to one of a jukebox mode, and a game mode;
receiving a mode command; and
determining a next mode of operation based on the mode command, the next mode of operation corresponding to one of a game mode and a jukebox mode.

12. The method of claim 11, wherein the operating step and the determining step select a mode of operation corresponding to one of a dart game mode and a jukebox mode.

13. The method of claim 12, wherein said step of receiving a mode command comprises:
providing an input device by which a patron may input the mode command; and
detecting the mode command input by the patron.

14. The method of claim 12, further comprising the step of playing jukebox music in the background during a game.

15. The method of claim 12, wherein the operating step comprises operating in one of a dart game mode, a jukebox mode, and an advertising mode.

16. The method of claim 12, wherein the determining step comprises determining the next mode of operation based on the mode command and on the current mode.

17. The method of claim 12, further comprising resuming operation in a previous mode of operation when the current mode of operation is completed.
